(19) United States
(12) Patent Application Publication
(10) Pub. No.: US 2023/0341240 A1
(43) Pub. Date: Oct. 26, 2023

(54) METHOD AND PROCESSOR CIRCUIT FOR UPDATING A DIGITAL ROAD MAP

(71) Applicant: AUDI AG, Igolstadt (DE)

(72) Inventors: Simon SEITLE, Oberhausen (DE); Andreas JANDER, Ingolstadt (DE); Florian HENKENHAF, Ingolstadt (DE)

(73) Assignee: AUDI AG, Ingolstadt (DE)

(21) Appl. No.: 17/799,357

(22) PCT Filed: Dec. 10, 2020
(86) PCT No.: PCT/EP2020/085403

§ 371 Date: Aug. 12, 2022

(30) Foreign Application Priority Data
Feb. 14, 2020 (DE) 10 2020 103 906.9

(51) Int. Cl. G01C 21/00

(52) U.S. Cl. CPC G01C 21/3822; G01C 21/3841

(57) ABSTRACT

A method of updating a digital road map which contains spatially resolved description values of at least one mapped environmental characteristic for at least one mapped road. A virtual journey along the at least one mapped road may be simulated, on basis of the road map to be updated, by a processor circuit before the updating process. The road map may be used to determine, for different virtual geopositions, an associated virtual measurement value of the at least one mapped environmental characteristic The virtual measurement values may be used to generate, for the virtual geopositions, a concatenated data record which describes the virtual journey. Newly received concatenated data records of real journeys of measuring motor vehicles and the concatenated data records of the virtual journey may be combined. The updated road map may be calculated from the combined received concatenated data records of real journeys and the virtual concatenated record.--

### CROSS-REFERENCE TO RELATED APPLICATIONS

This application is a U.S. national stage of International Application No. PCT/EP2020/085403, filed on Dec. 10, 2020. The International Application claims the priority benefit of German Application No. 10 2020 103 906.9, filed on Feb. 14, 2020. Both the International Application and the German Application are incorporated by reference herein in their entirety.

### FIELD

The present description relates to a method of updating a digital road map in which at least one road is mapped, and spatially resolved description values of at least one mapped environmental property, for example, an ambient temperature or a road condition, may be included along a course of the at least one mapped road. Described is also a processor circuit which can be used to carry out the method.

### BACKGROUND

Measurements from a plurality of motor vehicles which drive in an environment along the roads situated there and measured values for different environmental properties, for example said ambient temperature or road condition, can be used to create a digital road map. Measurement data which represent logically strung together or concatenated data sets therefore result for each motor vehicle. This is because each data set indicates, for a particular geo-position, which measured value was measured there for the environmental property to be respectively measured. The concatenation of the data sets therefore results from the temporal sequence in which the geo-positions were passed during the respective journey. The concatenated data set therefore corresponds to the driven trajectory, along which the motor vehicle has driven on its respective journey. Measurement data which, as logically concatenated data sets, indicate measured values for different geo-positions are also referred to as a “graph” below since the method of presentation of the measurement data corresponds to the mathematical graph of nodes and edges.

A central processor circuit, for example an Internet server, may receive, for or from a plurality of motor vehicles, their respective graphs of concatenated data sets for a journey, with the result that the concatenated data set which describes the measured values measured at different geo-positions along a trajectory is available in the processor circuit for each motor vehicle for a respective journey. If a plurality of motor vehicles drive along the same road, a plurality of graphs of concatenated data sets are therefore available for this road. The measured values from the different motor vehicles may differ from one another because sensors of different quality (scattering) and/or different measurement conditions existed, for example. The graphs of the concatenated data sets from different motor vehicles or generally different journeys (by the same motor vehicle or different motor vehicles) can be combined using algorithms which are known per se. The measured values combined as a result are referred to as description values below. These are entered in the road map in order to describe the environmental property to be measured or mapped in a spatially resolved manner for different geo-positions.

However, if new concatenated data sets then appear, it is nowadays not possible to subsequently integrate these new measurement data in a completed digital road map. Therefore, all measurement data to be taken into account must always be held in a memory as raw data, that is to say all concatenated data sets, and, whenever the road map needs to be updated, the old concatenated data sets which have already been taken into account must be linked to or combined with the newly added concatenated data sets again by a predetermined algorithm in order to again obtain description values for the road map. This means that the process of updating a digital road map or keeping the digital road map up-to-date uses a lot of memory and may be computing-intensive. An example of a suitable algorithm may be the so-called SLAM (Simultaneous Localization and Mapping) method.

The practice of collecting measurement data from a plurality of motor vehicles and calculating a digital road map on the basis of these measurement data is described in US 2017/0248963 A1, for example. A description is given of how a 3-D mapping unit can calculate a 3-D road map of an environment from graph data of the described type and measurement data from a LIDAR.

US 2019/0003838 A1 discloses a method for calculating a lane-accurate road map from measurement data from different motor vehicles.

CN 109117718 A1 discloses how measured values from individual motor vehicles can be combined to form a description value. Individual point measurements are used here as measured values, with the result that the combination of the measured values results in a three-dimensional point cloud, which point clouds are then offset, by a statistical evaluation, to form a description value combining the measured values.

### SUMMARY

The described examples involve subsequently updating a digital road map, which is based on measured values from measurements by individual motor vehicles, on the basis of additional measured values.

The described examples may be subjects of patent claims. Advantageous examples may be described by the patent claims, the following description and the figures.

Described may be a method of updating a digital road map. Such a road map may represent a model of an environment, that is to say the geometrical course of at least one road in the environment. In this case, spatially resolved description values of at least one mapped environmental property may be included in the respective region of the at least one mapped road. Such an environmental property may be, for example, in the manner described, the ambient temperature or the road condition (surface property such as rough, smooth, sandy, or the road class such as freeway, country road) or an achievable average driving speed or an applicable legal speed limit. The road map may be described by map data or model data. In order to update the road map, that is to say the model data, a processor circuit respectively receives at least one graph of concatenated data sets from at least one measuring vehicle according to the method. Such a graph of concatenated data sets respectively describes a journey of the motor vehicle, that is to say the trajectory driven or covered by the motor vehicle. The data sets are therefore lined up along the driven route. In each graph of concatenated data sets, each individual data set respectively indicates, for a geo-position which has been passed during the journey, at least one measured value measured or captured at this geo-position. This may be a measured value for an environmental property which has already been mapped or a measured value for a new environmental property to be additionally mapped. Whenever a motor vehicle therefore captures a measured value, the motor vehicle can store this measured value, together with measured values for the geo-position and, for example, the spatial orientation of the motor vehicle (so-called pose), as a data set. If a plurality of measured values are measured at the same geo-position (for example temperature and road condition), these measured values can be stored, together with the geo-position, in a common data set. The geo-position itself may also constitute a measured value if the intention is to map the road course or lane course. The series or chain of data sets which belong to the same journey then results in the graph of concatenated data sets.

In order to now integrate the at least one received graph of concatenated data sets in the model data or map data relating to an already existing digital road map, the following may be provided according to the described examples.

Before the updating of the existing digital road map, on the basis of the (already available) road map to be updated, the processor circuit simulates a virtual journey along the at least one mapped road (in the road map). This may be carried out by reading out or determining a respective virtual measured value of the at least one environmental property which has already been mapped from the road map, for different virtual geo-positions. Such a virtual measured value may correspond to a description value from the road map or to an interpolation value from a plurality of the description values. In other words, the road map is therefore sampled, specifically at each of the virtual geo-positions. These geo-positions can be randomly determined by an algorithm, for example, or can be stipulated according to a predetermined sampling pattern. During a real journey, a concatenated data set describing the virtual journey can now be generated from the virtual geo-positions and the virtual measured values. There is therefore a description of the road map which has the same format as the newly received measured values for real journeys (specifically graphs of concatenated data sets). The received concatenated data sets for the respective real or actual journey of the at least one motor vehicle and the concatenated data sets for the virtual journey may then be combined by the processor circuit, that is to say updated description values may therefore be calculated for the at least one environmental property. The updated road map is then calculated from these combined data sets, that is to say the described map data or model data are generated again, for example. The operations of combining the concatenated data sets and calculating the updated road map can be carried out here using a conventional or already known algorithm which also generated the original road map to be updated, since the description of the previous road map is also available as a graph of concatenated data sets, with the result that the concatenated data sets can be processed like a graph for a real journey.

The described examples may result in the advantage that new measured values can be subsequently integrated or incorporated in an already existing digital road map without the original measured values also having to be stored or be available for this purpose. This means that the process of keeping the road map up-to-date saves resources since neither storage space for the old concatenated data sets which have already been taken into account is required nor must all respectively available concatenated data sets be offset against one another for updating, which would increase with increasing measured values. The concatenated data sets which have already been taken into account in the road map are instead represented as a concatenated data set for a virtual journey.

The described examples may result in additional advantages.

In one example, the processor circuit transmits the finished updated road map to at least one motor vehicle using the road map. Updated map data or model data which are available or are used in the respective motor vehicle for navigation assistance and/or for operating an autonomous driving function are therefore available in the motor vehicle using the road map. A motor vehicle can therefore be guided or navigated using the updated road map.

In one example, a respective weighting factor may be applied to the data sets during said combining of the concatenated data sets (that is to say the data sets for the virtual journey or the respective real journey of the at least one motor vehicle). The respective value of the weighting factor may set or stipulate an influence of the respective data set on the updated road map (that is to say on the description values to be newly calculated). The value for the weighting factor of the concatenated data sets for the virtual journey can therefore be set to be greater than the value of the weighting factor for the respective real journey. This makes it possible to express the fact that the concatenated data sets for the virtual journey represent a larger set of measured values for each geo-position than those that newly appear as a result of the real journeys. The sum of the values of the weighting factors may be 1. Vice versa, provision may also be made for a weighting factor of a data set for a real journey (or the sum of the weighting factors of the data sets for a plurality of real journeys) to be given a higher value overall than the weighting factor of a data set for the virtual journey. This may be provided, for example, if there is a signal indicating that there has been a change in the environment, for example a changed road course is detected or signaled. If more than a predetermined minimum number of graphs of concatenated data sets, for example, signal that the trajectory covered by the associated motor vehicle differs significantly from the course or the geometry of the previously mapped roads, this may be interpreted as an indication or signal of a changed road course and the values of the weighting factors may be adapted or changed so that the weighting factor for the new concatenated data sets is greater than for the concatenated data sets for the virtual journey (previous map data). A person skilled in the art can determine what is assessed as significant by a predetermined significance criterion.

In an example, the updated road map may be calculated by calculating updated, spatially resolved description values of the new environmental property or the at least one mapped environmental property in the digital road map, respectively described by the measured values, from the measured values and associated geo-positions (of all available concatenated data sets). For example, for the individual geo-positions, the measured values available there may be combined, or the measured values from predetermined regions, for example of areas having a size in the range of 10 m² to 100 m², can be combined to form a description value.

When combining the measured values, according to an example, as the respective description value, a mean value of the measured values assigned to this geo-position, because the measured values were measured at this geo-position, for example, or were measured in a predetermined region around this geo-position (for example in said area of between 10 m² and 100 m²) may be calculated. The description value may also be a statistical description value in which a statistical distribution of the available measured values is calculated from the latter and the respective description value is calculated therefrom, for example as the most likely value according to the statistical distribution determined. In this case, it is possible to take into account a form of the distribution, for example a bimodality (distribution with two maxima) or generally a multimodality (distribution with a plurality of maxima).

In one embodiment, the road map is iteratively updated on the basis of concatenated data sets received in temporal succession, that is to say several times in succession. In other words, the road map is not only updated once on the basis of at least one received graph of concatenated data sets, but rather graphs of concatenated data sets are available several times in succession and the update is then carried out again in each case. This makes it possible to keep the road map up-to-date during ongoing operation, that is to say while the processor circuit supplies motor vehicles using the road map with the model data relating to the road map in updated form.

In an example, concatenated data sets for real journeys which have already been taken into account may be deleted by the processor circuit. In other words, the concatenated data sets for real journeys which have already been taken into account in the road may therefore not be kept, meaning that they would otherwise occupy or block data memories. Rather, the processor circuit can manage with less memory since the concatenated data sets which have already been taken into account are represented in the road map, that is to say in the model data or map data, by the description values and a replacement for concatenated data sets for real journeys can be provided by generating concatenated data sets for the virtual journey.

The described processor circuit may be provided for carrying out the method according to the examples. This processor circuit likewise constitutes part of the examples. The processor circuit according to the examples has at least one microprocessor which may be coupled to a data memory which stores program instructions which, during execution by the at least one microprocessor, cause the latter to carry out a method according to the described examples. The processor circuit may be in the form of an Internet server or a server cluster or server cloud.

Finally, the examples may also includes a computer-readable storage medium having a program code or program instructions which are configured, during execution by a processor circuit, to cause the latter to carry out a method according to the examples. The storage medium may be in the form of a hard disk or a flash memory or a CD-ROM or a DVD, for example.

The described measuring motor vehicles and the described motor vehicles using a road map may each be in the form of automobiles, in particular passenger vehicles or trucks, or in the form of a minibus or motorcycle.

The described examples may include implementations in which a combination of a plurality of the described examples may be implemented in each case.

### BRIEF DESCRIPTION OF DRAWINGS

Examples of the invention are described. In this respect, these and other aspects and advantages will become more apparent and more readily appreciated from the following description of the example embodiments, taken in conjunction with:

FIG. 1 shows a drawing for illustrating a known algorithm for generating model data relating to a road map from concatenated data sets, as can be used according to an example;

FIG. 2 shows a drawing for illustrating a graph of concatenated data sets; and

FIG. 3 shows a schematic illustration of one embodiment of the processor circuit according to an example.

### DESCRIPTION

In the described examples, the described components of the examples are each individual features which should be considered independently of one another and which also each may be developed independently of one another. Therefore, the disclosure is also intended to include combinations other than the illustrated combinations of the features of the examples. Furthermore, the described examples can also be supplemented by further features of the examples which have already been described.

In the figures, identical reference signs each denote functionally identical elements.

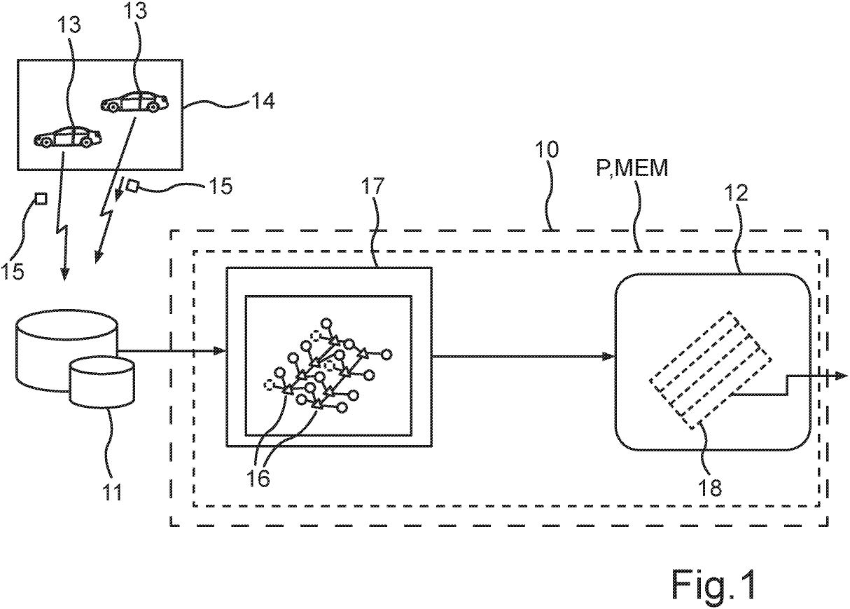

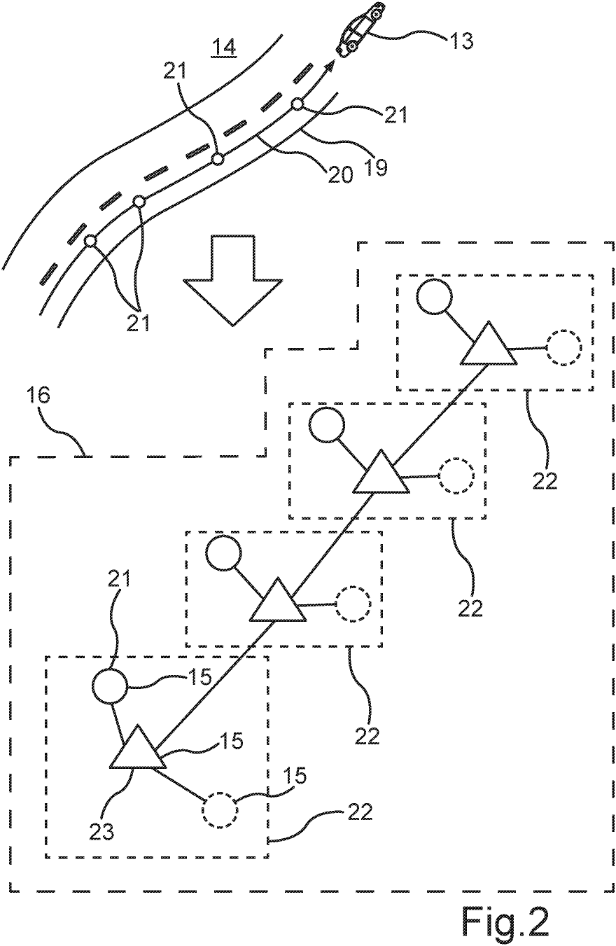

FIG. 1 shows a processor circuit 10 which may be provided, for example, in an Internet server and may be implemented by a computing center, for example. The processor circuit 10 may be based on one or more microprocessors (so-called CPUs - Central Processing Units). A digital road map 12 can be calculated from sensor data 11 by the processor circuit 10. The processor circuit 10 may receive the sensor data 11 from motor vehicles 13 which may be situated in a road network of an environment 14 and may describe the motor vehicles’ 13 measured values 15 for at least one environmental property of the environment 14, for example, the current temperature and/or a road condition and/or a position of lanes of the respective road. The measured values 15 may be represented by the sensor data 11. The measured values 15 of a journey of each of the motor vehicles 13 may be respectively combined overall to form a graph 16 of concatenated data sets, which will also be explained in more detail below in connection with FIG. 2.

The processor circuit 10 may be based on at least one microprocessor (P) and a data memory (MEM) which is coupled to the latter and may contain program instructions for the method described here.

The road map 12 can be calculated in a manner known per se from such graphs 16 of concatenated data sets by an algorithm 17 known per se from the related art, that is to say the road map 12 can be calculated overall from the measured values 15 in a data format which can be stipulated by a predefinable data format. For example, it may be possible to choose a road format from a map provider wishing to use the road map 12. Such a road map 12 may describe, for example, lane courses and/or center line courses and/or lane boundaries and/or landmarks. A local distribution of at least one environmental property may be described by description values in the road map.

FIG. 2 again illustrates the structure of the measured values 15 in the graphs 16. FIG. 2 illustrates how a motor vehicle 13 can carry out a journey 20 along a road 19 in the environment 14. The road 19 may be intended to be mapped in the road map 12. Along the route or road 19, the motor vehicle 13 can respectively measure, at different geo-positions 21, the geo-position 21 itself and optionally at least one further measured value 15 (also see FIG. 1) during the journey 20 in a manner known per se using an on-board sensor circuit. The measurement of the geo-position 21 itself may also constitute a measured value 15 in the sense of the examples.

A graph 16 of concatenated data sets 22 may now be formed from the measured values 15. In this case, each data set 22 represents the measurement or the measurement result at one of the geo-positions 21. The data set 22 may here describe, for example, measurement data relating to a pose 23 of the motor vehicle 13, as held by the motor vehicle at the geo-position 21, a measurement of the geo-position 21 itself, for example, expressed as coordinates of a GNSS (Global Navigation Satellite System), for example, of a GPS (Global Positioning System). In addition, a measured value 15 may optionally also be obtained, for example, from another sensor of the motor vehicle 13, for example a temperature value and/or an air quality value and/or a brightness value, to mention as examples. For the sake of clarity, only one data set 22 is completely provided with reference signs in FIG. 2. The temporal sequence in which the motor vehicle 13 has passed the geo-positions 21 in succession may result in the order or sequence of the data sets 22 in the graph 16. Such a graph 16 may be represented by sensor data 11 and may be received by the processor circuit 10 from the motor vehicle 13 (for example via an Internet connection) and, together with further graphs 16 for further journeys and/or from further motor vehicles, may be converted into the model data 18 for the road map 12 by the processor circuit 10 in the described manner by the algorithm 17. In this case, the individual measured values may then be combined in order to obtain description values of the road 19 and/or of a further environmental property therefrom, which description values represent, for example, a parameterized line or another format known per se. The individual measured values 15 may then actually no longer be necessary for the road map 12.

The algorithm 17 described in connection with FIG. 1 and as may be known per se from the related art may only be able to calculate a road map 12 on the basis of raw data, that is to say the graphs 16 containing the concatenated data sets or precisely on the basis of the measured values 15. If there is already a finished road map 12, no further additional new information from measured values 15 received at a later time can consequently be integrated in these map data or these model data 18 relating to the road map 12 by the algorithm 17 alone.

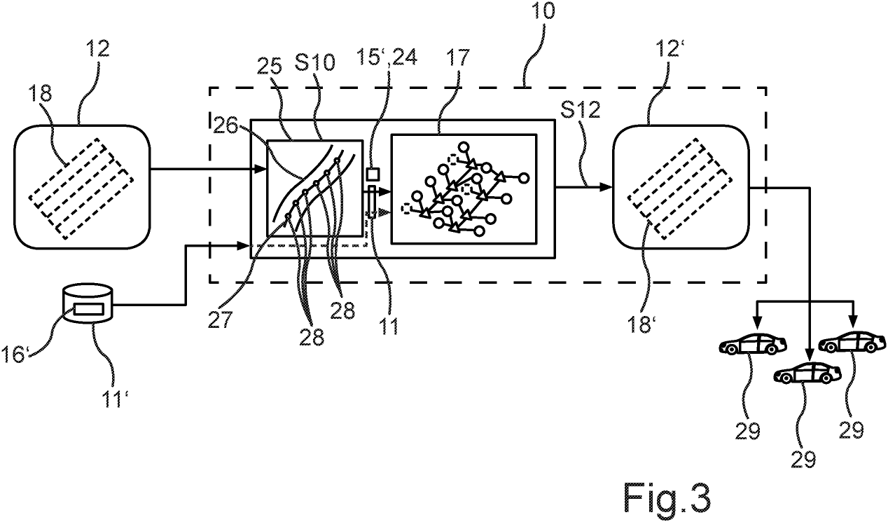

FIG. 3 illustrates how an updated road map 12′ containing updated model data 18′ can now be calculated on the basis of the model data 18 relating to the road map 12 (already existing description values) if new additional sensor data 11′ containing additional graphs 16′ of concatenated data sets, that is to say additional measured values, arrive or are received.

The algorithm 17 itself may need not be adapted or changed for this purpose. Rather, the processor circuit 10 can use the graphs 16′ and can combine the graph 16′ with artificially generated virtual measured values 15′ which are combined to form a graph 24 which can be structured in the same manner as the graph 16 described in FIG. 2, that is to say the graph 24 need not differ from the newly received graphs 16′ in terms of data structure. For this purpose, the processor circuit 10, in a first operation S10, can operate a simulation module 25 which can simulate a virtual journey 27 on the roads 26 which have already been mapped on the basis of the already existing road map 12, that is to say the road map’s 12 model data 18 with the description values contained therein, by respectively generating or carrying out at least one artificial measured value 15′, that is to say a virtual measurement, for different virtual geo-positions 28. The simulation module 25 may be a computer program. In this case, the respective artificial measured value 15′ describes the respective description value of the respective environmental property which has already been mapped in the road map 12, which description value is stored or described in the model data 18 relating to the road map 12. The described interpolation may also be provided.

The result is therefore artificial measured values 15′ which can be combined to form a graph 16 of concatenated data sets in the manner described in FIG. 2. Therefore, these artificially generated graphs 24 also have the structure which can also be generated by a motor vehicle 13 on a real journey. For the algorithm 17, there is therefore no difference between new information and the information which has already been mapped, and, in operation S11, the graphs 24 and the newly received graphs 16′ can be processed together in the same manner by the algorithm 17, thus generating the model data 18′ relating to the updated road map 12′. For this purpose, it may not be necessary to hold the graphs 16 originally taken as a basis (see FIG. 1). These may be deleted from the processor circuit 10 after the first version of the road map 12 has been generated.

The road map 12 and the updated road map 12′ may each be made available to at least one motor vehicle using a road map in operation S12 after the road maps 12, 12′ have been finished. Measured values 15 can therefore be iteratively or repeatedly received from motor vehicles 13, may be processed iteratively or in succession by the processor circuit 10, and respective updated road maps 12′ can be output or transmitted to motor vehicles using the updated road maps 12′. A continuous or stepwise update of the road map 12 in the motor vehicles using the updated road maps 12′ on the basis of measuring motor vehicles 13 can therefore be continuously operated or enabled. The motor vehicles 29 using the updated road maps 12′ may therefore be coupled to the measuring motor vehicles 13 via the processor circuit 10 and may be supplied with updated model data 18′ relating to an updated road map 12′ in stages or steps.

This makes it possible for many vehicle manufacturers to create map material with their own observations of the vehicle sensor set (sensor circuits of the measuring motor vehicles), to keep the map material up-to-date or to update changes in order to create a new version of a base map, for example. The observations from the sensor environment are converted into a graph representation by way of a processing. However, for navigation assistance in using motor vehicles, the information to be updated must be in a format which can be interpreted by the calculating entity of the base map (road map to be updated). The tried and tested mapping process can be gathered from FIG. 1. This FIG. 1 process can be assumed to be the starting point for the examples described below.

In order to generate the model of this base map, it may be necessary to process the vehicle sensor information of different origins (for example different vehicle manufacturers, derivatives, to mention examples) in the map section to be calculated. This situation is due to the correspondence search which constitutes the basis for determining identity factors between the items of information which appear. In this case, it may now no longer be necessary to recurrently resort to established data sets or subsets of the latter. This saves an enormous volume of resources (memory, RAM and CPU load). In addition, a massive amount of computing effort and time, which needs to be expended to resolve the correspondence search and the optimization problem (SLAM method), may be prevented. In addition, from the point of view of data protection law, the purpose limitation of personal information is taken into account since the data set concerned can be deleted after initial processing.

In order to minimize the amount of computing effort, time, resources and complexity, a conversion of the calculated initial map which already exists (own generated maps or from third-party providers) into a graph representation is provided. The examples describe how virtual observations and/or virtual geo-positions, which constitute the basis for virtual journeys, can be created as an input from a base map. These virtual variables may then be converted into a graph structure, which may includes virtual journeys which have already been processed and/or optimized. The corresponding processes can be gathered from FIG. 3.

On the basis of the described examples, new sessions (data relating to an added recording journey) can be individually and directly processed, which may significantly accelerate the correspondence search and the subsequent graph optimization and therefore enormously saves resources. In addition, the raw data could be deleted after processing with the overall graph since the raw data may no longer be required to calculate a map model again.

As already described, the virtual graph variables are generated from an imported map model. The generated variables may be fixed during graph optimization. The generated model can therefore be considered to be ground truth. It is particularly advantageous to ensure that a sufficient information content of a generated graph is available for the respective correspondence search. The following elements or operations can be used for the generation:
import of reference map model according to the data structure of the calculating entity/library;
interpolation of polyline geometries in the case of continuous objects such as polylines (linear observations exist only from very few supporting points, with the result that description values are now generated here for additional virtual geo-positions);
calculation of virtual geo-positions by sampling a reference path;
calculation of virtual observed objects;
linking of virtual geo-positions to associated virtual objects.

Overall, the examples show how a map model can be converted into a graph representation.

A description has been provided with particular reference to examples, but it will be understood that variations and modifications can be effected within the spirit and scope of the claims, which may include the phrase “at least one of A, B and C” as an alternative expression that refers to one or more of A, B or C, contrary to the holding in Superguide v. DIRECTV, 358 F3d 870, 69 USPQ2d 1865 (Fed. Cir. 2004).

1-6. (canceled)

7. A method of updating a digital road map which respectively contains spatially resolved description values of at least one mapped environmental property for at least one mapped road, comprising:
by a processor circuit,
respectively receiving, for at least one measuring motor vehicle, at least one graph of first concatenated data sets which describe a respective real journey of the motor vehicle,
a graph, from among the at least one graph, of the first concatenated data sets, a first data set, from among the first concatenated data sets, indicates, for a received geo-position which was passed during the real journey, at least one measured value captured at the received geo-position for a new environmental property or the at least one mapped environmental property in the digital road map;
before the updating of the digital road map, simulating a virtual journey along the at least one mapped road by,
determining a respective virtual measured value of the new environmental property or the at least one mapped environmental property in the digital road map, from the digital road map for different virtual geo-positions, the virtual measured value corresponding to a description value from the digital road map or to an interpolation value from a plurality of the description values,
generating a second concatenated data set describing the virtual journey from the virtual measured value for a virtual geo-position, from among the different virtual geo-positions,
combining the first concatenated data sets for the respective real journey of the at least one motor vehicle and the second concatenated data set for the virtual journey,
calculating the updated road map from the combined first and second concatenated data sets by,
calculating updated, spatially resolved description values of the new environmental property or the at least one mapped environmental property in the digital road map, respectively described by the at least one captured measured value and the virtual measured value, from the at least one captured measured value and the virtual measure value and the received geo-position and the different virtual geo-positions of the first and second concatenated data sets, in which at a respective virtual geo-position, from among the different virtual geo-positions,
a mean value of the at least one captured measured value and the virtual measured value is calculated to be assigned to the received geo-position as measured at the received geo-position or in a region around the real geo-position, or
a statistical distribution of the at least one captured measured value or the virtual measured value is determined, and
the respective description value is determined from the calculated mean value or the statistical distribution; and
iteratively updating the digital road map on basis of the first concatenated data sets received in temporal succession.

8. The method as claimed in claim 7, wherein the processor circuit transmits the updated road map to at least one motor vehicle using the digital road map.

9. The method as claimed in claim 7, wherein a respective weighting factor is applied to the first and second concatenated data sets when combining the first and second concatenated data sets.

10. The method as claimed in claim 7, wherein the first concatenated data set for the real journey already taken into account is deleted by the processor circuit.

11. A processor circuit having at least one microprocessor (P) and having a data memory (MEM) which stores program instructions which, during execution by the at least one microprocessor (P), cause the at least one microprocessor to carry out a process to update a digital road map which respectively contains spatially resolved description values of at least one mapped environmental property for at least one mapped road, the process comprising:
respectively receiving, for at least one measuring motor vehicle, at least one graph of first concatenated data sets which describe a respective real journey of the motor vehicle,
a graph, from among the at least one graph, of the first concatenated data sets, a first data set, from among the first concatenated data sets, indicates, for a received geo-position which was passed during the real journey, at least one measured value captured at the received geo-position for a new environmental property or the at least one mapped environmental property in the digital road map;
before the updating of the digital road map, simulating a virtual journey along the at least one mapped road by,
determining a respective virtual measured value of the new environmental property or the at least one mapped environmental property in the digital road map, from the digital road map for different virtual geo-positions, the virtual measured value corresponding to a description value from the digital road map or to an interpolation value from a plurality of the description values,
generating a second concatenated data set describing the virtual journey from the virtual measured value for a virtual geo-position, from among the different virtual geo-positions,
combining the first concatenated data sets for the respective real journey of the at least one motor vehicle and the second concatenated data set for the virtual journey,
calculating the updated road map from the combined first and second concatenated data sets by,
calculating updated, spatially resolved description values of the new environmental property or the at least one mapped environmental property in the digital road map, respectively described by the at least one captured measured value and the virtual measured value, from the at least one captured measured value and the virtual measure value and the received geo-position and the different virtual geo-positions of the first and second concatenated data sets, in which at a respective virtual geo-position, from among the different virtual geo-positions,
a mean value of the at least one captured measured value and the virtual measured value is calculated to be assigned to the received geo-position as measured at the received geo-position or in a region around the real geo-position, or
a statistical distribution of the at least one captured measured value or the virtual measured value is determined, and
the respective description value is determined from the calculated mean value or the statistical distribution; and
iteratively updating the digital road map on basis of the first concatenated data sets received in temporal succession.

12. The processor circuit as claimed in claim 11, wherein the processor circuit transmits the updated road map to at least one motor vehicle using the digital road map.

13. The processor circuit as claimed in claim 11, wherein a respective weighting factor is applied to the first and second concatenated data sets when combining the first and second concatenated data sets.

14. The processor circuit as claimed in claim 11, wherein the first concatenated data set for the real journey already taken into account is deleted by the processor circuit.

15. A storage medium (MEM) having a program code which is configured, during execution by a processor circuit, to cause the processor circuit to carry out a process to update a digital road map which respectively contains spatially resolved description values of at least one mapped environmental property for at least one mapped road, the process comprising:
respectively receiving, for at least one measuring motor vehicle, at least one graph of first concatenated data sets which describe a respective real journey of the motor vehicle,
a graph, from among the at least one graph, of the first concatenated data sets, a first data set, from among the first concatenated data sets, indicates, for a received geo-position which was passed during the real journey, at least one measured value captured at the received geo-position for a new environmental property or the at least one mapped environmental property in the digital road map;
before the updating of the digital road map, simulating a virtual journey along the at least one mapped road by,
determining a respective virtual measured value of the new environmental property or the at least one mapped environmental property in the digital road map, from the digital road map for different virtual geo-positions, the virtual measured value corresponding to a description value from the digital road map or to an interpolation value from a plurality of the description values,
generating a second concatenated data set describing the virtual journey from the virtual measured value for a virtual geo-position, from among the different virtual geo-positions,
combining the first concatenated data sets for the respective real journey of the at least one motor vehicle and the second concatenated data set for the virtual journey,
calculating the updated road map from the combined first and second concatenated data sets by,
calculating updated, spatially resolved description values of the new environmental property or the at least one mapped environmental property in the digital road map environmental property, respectively described by the at least one captured measured value and the virtual measured value, from the at least one captured measured value and the virtual measure value and the received geo-position and the different virtual geo-positions of the first and second concatenated data sets, in which at a respective virtual geo-position, from among the different virtual geo-positions,
a mean value of the at least one captured measured value and the virtual measured value is calculated to be assigned to the received geo-position as measured at the received geo-position or in a region around the real geo-position, or
a statistical distribution of the at least one captured measured value or the virtual measured value is determined, and
the respective description value is determined from the calculated mean value or the statistical distribution; and
iteratively updating the digital road map on basis of the first concatenated data sets received in temporal succession.

16. The storage medium as claimed in claim 15, wherein the processor circuit transmits the updated road map to at least one motor vehicle using the digital road map.

17. The storage medium as claimed in claim 15, wherein a respective weighting factor is applied to the first and second concatenated data sets when combining the first and second concatenated data sets.

18. The storage medium as claimed in claim 15, wherein the first concatenated data set for the real journey already taken into account is deleted by the processor circuit.
